(19) United States
(12) Patent Application Publication
(10) Pub. No.: US 2012/0103034 A1
(43) Pub. Date: May 3, 2012

(54) Lock for locking a movable member to fixed member

(76) Inventor: Mark W. Shartel, San Diego, CA (US)

(21) Appl. No.: 12/925,895

(22) Filed: Nov. 1, 2010

(51) Int. Cl. E05B 21/06; F16B 39/02

(52) U.S. Cl. 70/352; 411/190

(57) ABSTRACT

A lock for locking a movable member to a fixed member, wherein the movable member has a recess, and wherein the fixed member has a threaded through bore. The lock includes a head, a stem, first locking apparatus, and an optional second locking apparatus. The head is for selective rotational resting in the recess in the movable member. The stem selectively movably depends from the head and is for selectively engaging in the threaded through bore in the fixed member. The first locking apparatus selectively prevents rotation of the head relative to the stem to thereby prevent rotation of the stem and withdrawal thereof from the threaded through bore in the fixed member to thereby selectively prevent removal of the lock from the fixed member. The second locking apparatus depends operatively from the stem, is operatively connected to the first locking apparatus, and is for selectively preventing retraction of the stem from the threaded through bore in the fixed member to thereby further selectively prevent removal of the lock from the fixed member.

### 1. BACKGROUND OF THE INVENTION

A. Field of the Invention

An embodiment of the present invention relates to a lock, and more particularly, an embodiment of the present invention relates to a lock for locking a movable member to a fixed member.

B. Description of the Prior Art

Numerous innovations for locks have been provided in the prior art, which will be described below in chronological order to show advancement in the art, and which are incorporated herein by reference thereto. Even though these innovations may be suitable for the specific individual purposes to which they address, however, they differ from an embodiment of the present invention.

(1) U.S. Pat. No. 2,098,189 to Kistner.

U.S. Pat. No. 2,098,189 issued to Kistner on Nov. 2, 1937 teaches a bolt lock including a housing, and a cylindrical bolt mounted therein for sliding and rotating movement. One end of the bolt is adapted for projection into a cooperating socket member in its locking position, and the other end is grooved to receive a key. An abutment is on the bolt, spaced from its locking end. A spring surrounds the bolt, between the abutment and a fixed part of the housing for retracting the bolt from its locking position. A transverse abutment is in the housing, intermediate the ends of the bolt. The transverse abutment is spaced between the bolt abutment and the grooved end of the bolt in its unlocked position thereof. Apparatus is on the bolt for engaging the transverse abutment in its locking position to retain it against pressure of the spring. Rotation of the bolt serves to disengage the apparatus from the transverse abutment to permit retraction of the bolt. A key-activated apparatus is carried by the bolt to lock it against rotation in its locking position.

(2) U.S. Pat. No. 3,492,841 to Ipri.

U.S. Pat. No. 3,492,841 issued to Ipri on Feb. 3, 1970 teaches protection against theft or other unauthorized removal of articles secured by threaded nuts or the like through provision of auxiliary nuts and removable housings therefor adapted to enclose the securing nuts and prevent their removal, except after interlocking of the housing and auxiliary nut through instrumentality of a distinctive, and not readily duplicated, key element and removal of the auxiliary nut to affords access to the securing one.

(3) U.S. Pat. No. 4,480,513 to McCauley et al.

U.S. Pat. No. 4,480,513 issued to McCauley et al. on Nov. 6, 1984 teaches a bolt-type of lock structure including an elongated bolt member, first and second externally threaded ends on the bolt member, first and second nuts of frustoconical configuration threadably mounted on the first and second threaded ends, first and second faces on the nuts for receiving key members for tightening and loosening the nuts, and an anaerobic thread locking compound on the threads. The bolt member is relatively soft throughout to withstand impact, and has a hardened zone in a central area wherein it is exposed to chiseling or sawing. A nut of the type described above, which includes a threaded bore in the face that receives a screw for securing the key member thereto. A stud has oppositely threaded ends and an irregular axial bore in one end is for receiving a wrench, and a hardened surface portion between the threaded ends.

(4) U.S. Pat. No. 4,569,259 to Rubin et al.

U.S. Pat. No. 4,569,259 issued to Rubin et al. on Feb. 11, 1986 teaches a correspondingly keyed combination of a round-headed bolt fastener and a generally cylindrical socket, preferably, for use in securing an automobile wheel cover against theft. The fastener has a plurality of axial slots or lock impressions about the periphery of the circular head, which may be spaced in accordance with a preselected code. The wrench socket is provided with a corresponding number of key elements projecting inwardly from the cylindrical wall of the socket. The position of the key elements is in accordance with a preselected code. When the key code of the wrench matches the lock code of the fastener, the wrench socket is slipped over the fastener head, with the key elements engaging the lock impressions so that the wrench may tighten or untighten the fastener. The fastener has an axial recess extending from the outer face of the head, with an inner beveled surface about the recess opening. The head also has an outer beveled surface extending about its outer periphery, which provides a bearing surface for supporting the key elements during rotation of the socket until the matched position of the key elements and the lock impressions is reached. The socket has an axial pin extending flush with the end plane of the socket for alignment with the fastener head recess to guide the wrench during initial engagement with the head. The socket also has an inner angled portion extending between the base of the socket and the axial wall portion, which matches the angle of the outer beveled surface of the fastener head. When the socket is in full engagement on the fastener head, the engagement of the central pin in the axial recess and the contact of the angled surface of the socket with the beveled surface of the head serve to stabilize the alignment of the wrench socket on the fastener head during transmission of torque from the wrench to the fastener.

(5) U.S. Pat. No. 4,723,866 to McCauley.

U.S. Pat. No. 4,723,866 issued to McCauley on Feb. 9, 1988 teaches a manhole cover locking bolt construction for locking a manhole cover to an associated frame, which includes a bolt having a threaded shank and an externally threaded head and an endless curvilinear groove in the top of the head for receiving a key of mating configuration for threading the bolt into and out of the manhole cover frame, and a cap for threadably mounting on the externally threaded head to protect the curvilinear groove against entry of foreign matter.

(6) U.S. Pat. No. 4,971,501 to Chavez.

U.S. Pat. No. 4,971,501 issued to Chavez on Nov. 20, 1990 teaches a self-locking lock nut to be applied to a shaft having an axial keyway. It is applied and removed with or without special tooling by virtue of a camming relationship between the teeth of a rotationally restrained axially biased lock ring, and the teeth of a rotatable nut ring that is threaded to the shaft, and which bears against a thrust washer to which the lock ring is retained.

(7) U.S. Pat. No. 5,265,452 to Dawson et al.

U.S. Pat. No. 5,265,452 issued to Dawson et al. on Nov. 30, 1993 teaches a bolt retraction mechanism that is enabled by an electronic signal to a stepper motor that causes the lock to be openable. The lock is internally powered by a generator operable by the operator. The operation of the generator is separate from the lock operations.

(8) U.S. Pat. No. 5,457,975 to Berger et al.

U.S. Pat. No. 5,457,975 issued to Berger et al. on Oct. 17, 1995 teaches a device for removing a damaged locking cylinder, which eliminates the need for removing the escutcheon plates, and which employs an internal locking bolt acting in concert with locking arms mounted on a locking plate to selectively tighten or loosen the locking cylinder as required by use of an external adjusting mechanism that mates and co-acts with the locking bolt. A cylinder protector is affixed over the locking cylinder to deter vandalism of the cylinder by use of a tool.

(9) U.S. Pat. No. 6,010,289 to DiStasio et al.

U.S. Pat. No. 6,010,289 issued to DiStasio et al. on Jan. 4, 2000 teaches a locking nut and bolt system utilizing a bolt with threads having a plurality of notches generally longitudinally spaced in a predetermined pattern. Each notch has a lock face and an opposing slope. The locking unit carries one or more tines. The tine has a distal tine end adapted to latch onto the lock face of the notch on the bolt, and when the distal tine end is not disposed in one or more notches, the tine end moves on the bolt thread crest. When the distal tine end is in the notch or notches, the lock face of the notch prevents counter-rotational movement of the bolt with respect to the nut when the distal tine end abuts the lock face. The locking unit supports the tine and is either cylindrical, rectangular, or on a perpendicular support face normal to a radial plane through the axial centerline of the nut thread. The locking unit may be on a nut insert or may be carried on the leg of a U, J, or S-shaped clip. The locking unit is recessed as a blind hole.

It is apparent that numerous innovations for locks have been provided in the prior art, which are adapted to be used. Furthermore, even though these innovations may be suitable for the specific individual purposes to which they address, however, they would not be suitable for the purposes of an embodiment of the present invention as heretofore described.

### 2. SUMMARY OF THE INVENTION

Thus, an object of an embodiment of the present invention is to provide a lock for locking a movable member to a fixed member, which avoids the disadvantages of the prior art.

Briefly stated, another object of an embodiment of the present invention is to provide a lock for locking a movable member to a fixed member, wherein the movable member has a recess, and wherein the fixed member has a threaded through bore. The lock includes a head, a stem, first locking apparatus, and an optional second locking apparatus. The head is for selective rotational resting in the recess in the movable member. The stem selectively movably depends from the head and is for selectively engaging in the threaded through bore in the fixed member. The first locking apparatus selectively prevents rotation of the head relative to the stem to thereby prevent rotation of the stem and withdrawal thereof from the threaded through bore in the fixed member to thereby selectively prevent removal of the lock from the fixed member. The second locking apparatus depends operatively from the stem, is operatively connected to the first locking apparatus, and is for selectively preventing retraction of the stem from the threaded through bore in the fixed member to thereby further selectively prevent removal of the lock from the fixed member.

The novel features considered characteristic of an embodiment of the present invention are set forth in the appended claims. An embodiment of the present invention itself, however, both as to its construction and to its method of operation together with additional objects and advantages thereof will be best understood from the following description of an embodiment when read and understood in connection with the accompanying figures of the drawing.

### 3. BRIEF DESCRIPTION OF THE FIGURES OF THE DRAWING

The figures of the drawing are briefly described as follows:

FIG. 1 is a diagrammatic cross sectional view of the lock of an embodiment of the present invention locking a movable member to a fixed member;

FIG. 2 is an enlarged diagrammatic perspective view of the lock of an embodiment of the present invention identified by ARROW 2 in FIG. 1;

FIG. 3 is a diagrammatic cross sectional view taken along LINE 3-3 in FIG. 2;

FIG. 4 is a reduced exploded diagrammatic prospective view of the lock of an embodiment of the present invention shown in FIG. 2;

FIG. 5 is an enlarged diagrammatic cross sectional view taken along LINE 5-5 in FIG. 4;

FIG. 5A is a reduced diagrammatic cross sectional view taken along LINE 5A-5A in FIG. 5;

FIG. 5B is a reduced diagrammatic cross sectional view taken along LINE 5B-5B in FIG. 5;

FIG. 6A is an enlarged diagrammatic cross sectional view taken along LINE 6A-6A in FIGS. 3, 4, and 5 of an embodiment of the pin arrangement of the first locking apparatus in the retracted position;

FIG. 6B is an enlarged diagrammatic cross sectional view taken along LINE 6B-6B in FIGS. 3, 4, and 5 of an embodiment of the pin arrangement of the first locking apparatus in the extended position;

FIG. 6C is an enlarged diagrammatic cross sectional view taken along LINE 6C-6C in FIGS. 3, 4, and 5 of another embodiment of the pin arrangement of the first locking apparatus in the retracted position;

FIG. 6D is an enlarged diagrammatic cross sectional view taken along LINE 6D-6D in FIGS. 3, 4, and 5 of another embodiment of the pin arrangement of the first locking apparatus in the extended position;

FIG. 7A is an enlarged diagrammatic cross sectional view of the area generally enclosed by the dotted curve identified by ARROW 7A in FIG. 5 of the second locking apparatus in the retracted-unlocked position;

FIG. 7B is an enlarged diagrammatic cross sectional view of the area generally enclosed by the dotted curve identified by ARROW 7B in FIG. 5 of the second locking apparatus in the extended-locked position;

FIG. 8 is a diagrammatic cross section of the lock of another embodiment of the present invention locking a movable member to a fixed member;

FIG. 9 is an enlarged diagrammatic perspective view of the lock of another embodiment of the present invention identified by ARROW 9 in FIG. 8;

FIG. 10 is a diagrammatic cross sectional view taken along LINE 10-10 in FIG. 9;

FIG. 10A is a reduced diagrammatic cross sectional view taken along LINE 10A-10A in FIG. 10; and

FIG. 10B is a reduced diagrammatic cross sectional view taken along LINE 10B-10B in FIG. 10.

### 4. LIST OF REFERENCE NUMERALS UTILIZED IN THE FIGURES OF THE DRAWING

### A. General

20 lock of embodiment of present invention for locking movable member 22 to fixed member 24
22 movable member
24 fixed member
26 recess in movable member 22
28 threaded through bore in fixed member 24

### B. Overall Configuration of Lock 20

30 head for selective rotational resting in recess 26 in movable member 22
32 stem for selectively engaging in threaded through bore 28 in fixed member 24
34 first locking apparatus
36 second locking apparatus

### C. Specific Configuration of Head 30

38 cap of head 30 for selective rotational resting in recess 26 in movable member 22
40 filler of head 30
42 open bottom of cap 38 of head 30
44 substantially closed top of cap 38 of head 30
48 ring of filler 40 of head 30
50 centrally and axially disposed through bore in ring 48 of filler 40 of head 30

### D. Specific Configuration of Stem 32

52 lower portion of stem 32
54 upper portion of stem 32
56 flange of stem 32
58 lower end of lower portion 52 of stem 32
60 threads of lower end 58 of lower portion 52 of stem 32 for selectively engaging in threaded through bore 28 in fixed member 24

### E. Specific Configuration of First Locking Apparatus 34

62 centrally and axially disposed through bore 62 in substantially closed top 44 of cap 38 of head 30 of first locking apparatus 34
64 centrally and axially disposed through bore in upper portion 54 of stem 32 of first locking apparatus 34
66 key lock cylinder of first locking apparatus 34
67 key of key lock cylinder 66 of first locking apparatus 34
68 pin arrangement of first locking apparatus 34
70 lower annular groove of upper portion 54 of stem 32 of first locking apparatus 34
72 upper annular groove of upper portion 54 of stem 32 of first locking apparatus 34
74 bosses in upper portion 54 of stem 32 of first locking apparatus 34

### F. Specific Configuration of Embodiment of Pin Arrangement 168 of First Locking Apparatus 134

134 first locking apparatus
168 pin arrangement of first locking apparatus 134
176 centrally disposed actuator rod of pin arrangement 168 of first locking apparatus 134
177 pair of ends of centrally disposed actuator rod 176 of pin arrangement 168 of first locking apparatus 134
178 pair of diametrically opposed and L-shaped pins of pin arrangement 168 of first locking apparatus 134
180 pair of legs of each diametrically opposed and L-shaped pin of pair of diametrically opposed and L-shaped pins 178 of pin arrangement 168 of first locking apparatus 134
182 pair of springs of pin arrangement 168 of first locking apparatus 134
184 notch in one leg of pair of legs 180 of each diametrically opposed and L-shaped pin of pair of diametrically opposed and L-shaped pins 178 of pin arrangement 168 of first locking apparatus 134

### G. Specific Configuration of Another Embodiment of Pin Arrangement 268 of First Locking Apparatus 234

234 first locking apparatus
268 pin arrangement of first locking apparatus 234
276 centrally disposed and oval-shaped actuator rod of pin arrangement 268 of first locking apparatus 234
277 pair of ends of centrally disposed and oval-shaped actuator rod 276 of pin arrangement 268 of first locking apparatus 234
278 pair of diametrically opposed and T-shaped pins of pin arrangement 268 of first locking apparatus 234
280 pair of legs of each diametrically opposed and T-shaped pin of pair of diametrically opposed and T-shaped pins 278 of pin arrangement 268 of first locking apparatus 234
282 pair of springs of pin arrangement 268 of first locking apparatus 234
284 notch in one leg of pair of legs 280 of each diametrically opposed and T-shaped pin of pair of diametrically opposed and T-shaped pins 278 of pin arrangement 268 of first locking apparatus 234

### H. Specific Configuration of Second Locking Apparatus 36

386 centrally and axially disposed through bore in lower portion 52 of stem 32 of second locking apparatus 36
388 centrally and axially disposed through bore in flange 56 of stem 32 of second locking apparatus 36
390 rod of second locking apparatus 36
392 pointed lower end of rod 390 of second locking apparatus 36
394 flanged upper end of rod 390 of second locking apparatus 36
396 spring of second locking apparatus 36
398 pair of levers of second locking apparatus 36
400 pair of diametrically opposed and T-shaped pins of second locking apparatus 36
402 pair of legs of each pin of pair of diametrically opposed and T-shaped pins 400 of second locking apparatus 36
404 pair of springs of second locking apparatus 36
406 ramped surface of one leg of pair of legs 402 of each pin of pair of diametrically opposed and T-shaped pins 400 of second locking apparatus 36

### I. Configuration of Another Embodiment of Lock 520

520 locking for locking movable member 22 to fixed member 24
530 head
532 stem
534 first locking apparatus

### 5. DETAILED DESCRIPTION OF A PREFERRED EMBODIMENT

### A. General

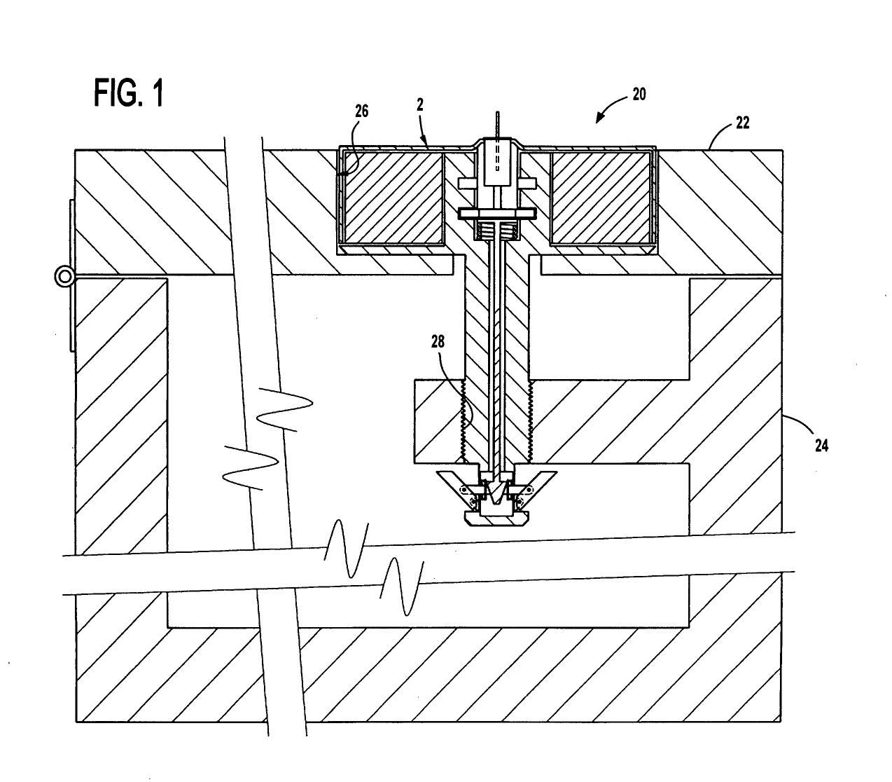

Referring now to the figures, in which like numerals indicate like parts, and particularly to FIG. 1, which is a diagrammatic cross sectional view of the lock of an embodiment of the present invention locking a movable member to a fixed member, the lock of an embodiment of the present invention is shown generally at 20 for locking a movable member 22 to a fixed member 24, wherein the movable member 22 has a recess 26 and the fixed member 24 has a threaded through bore 28.

### B. Overall Configuration of the Lock 20

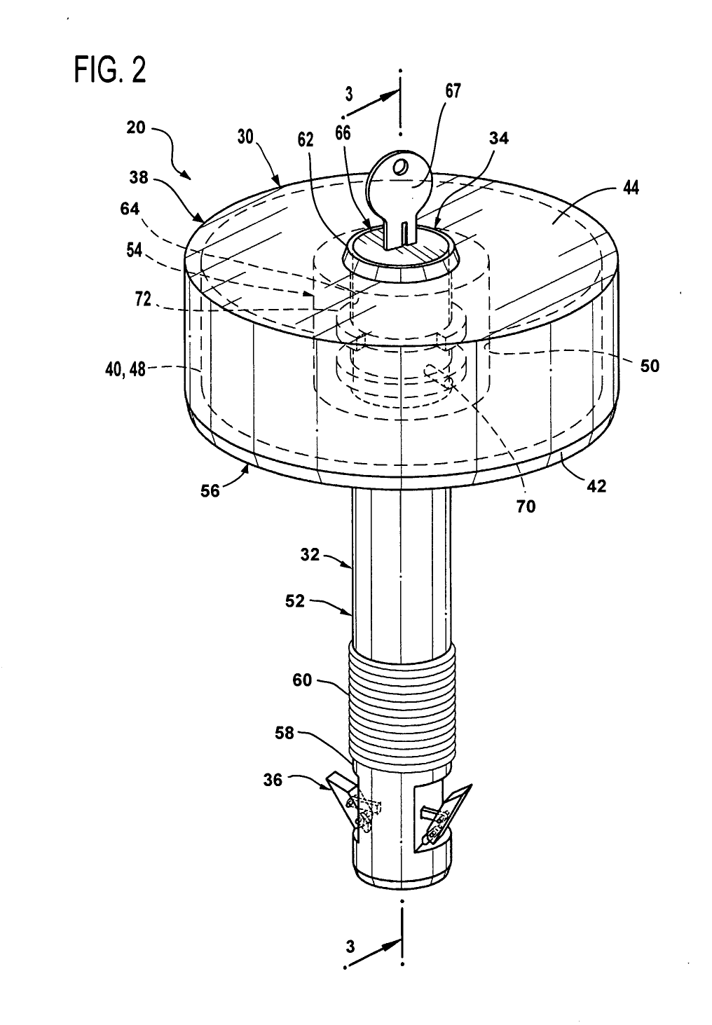

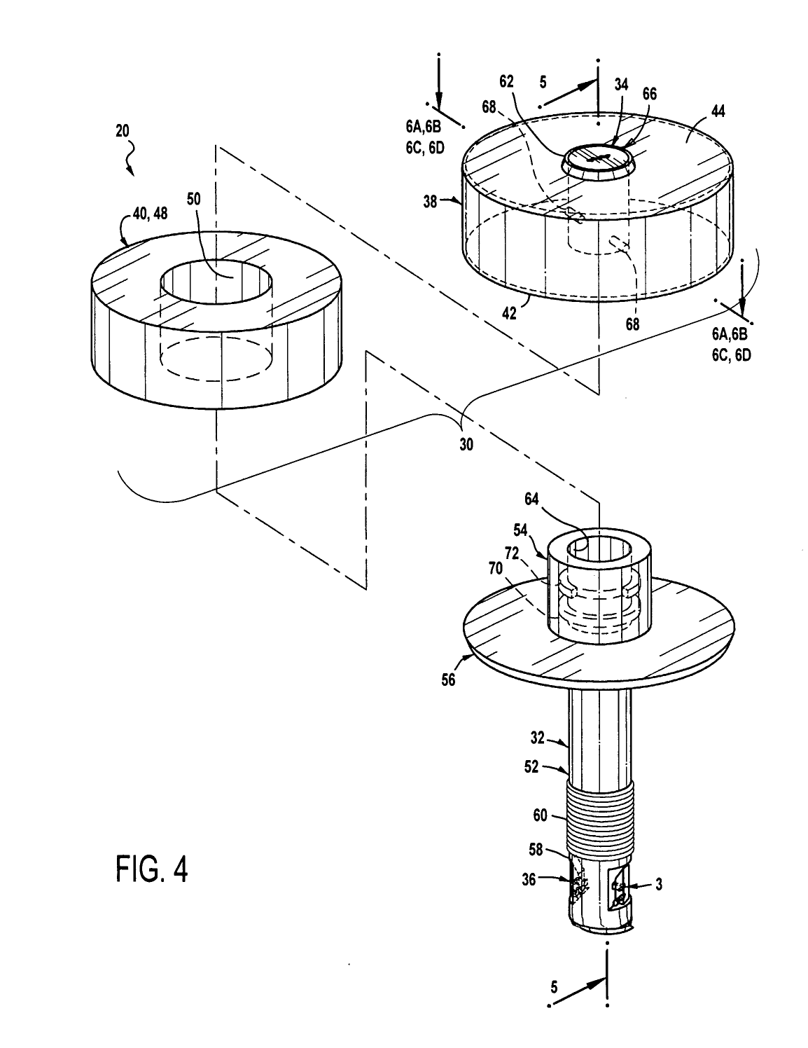

The overall configuration of the lock 20 can best be seen in FIGS. 2, 3, 4, and 5, which are, respectively, an enlarged diagrammatic perspective view of the lock of an embodiment of the present invention identified by ARROW 2 in FIG. 1, a diagrammatic cross sectional view taken along LINE 3-3 in FIG. 2, a reduced exploded diagrammatic prospective view of the lock of an embodiment of the present invention shown in FIG. 2, and an enlarged diagrammatic cross sectional view taken along LINE 5-5 in FIG. 4, and as such, will be discussed with reference thereto.

The lock 20 comprises a head 30, a stem 32, first locking apparatus 34, and an optional second locking apparatus 36.

The head 30 is for selective rotational resting in the recess 26 in the movable member 22.

The stem 32 selectively movably depends from the head 30 and is for selectively engaging in the threaded through bore 28 in the fixed member 24.

The first locking apparatus 34 selectively prevents rotation of the head 30 relative to the stem 32 to thereby prevent rotation of the stem 32 and withdrawal thereof from the threaded through bore 28 in the fixed member 24.

The second locking apparatus 36 depends operatively from the stem 32, is operatively connected to the first locking apparatus 34, and is for selectively preventing retraction of the stem 32 from the threaded through bore 28 in the fixed member 24 to thereby further selectively prevent removal of the lock 20 from the fixed member 24.

### C. Specific Configuration of the Head 30

The specific configuration of the head 30 can best be seen in FIGS. 2, 3, 4, and 5, which are, respectively, an enlarged diagrammatic perspective view of the lock of an embodiment of the present invention identified by ARROW 2 in FIG. 1, a diagrammatic cross sectional view taken along LINE 3-3 in FIG. 2, a reduced exploded diagrammatic prospective view of the lock of an embodiment of the present invention shown in FIG. 2, and an enlarged diagrammatic cross sectional view taken along LINE 5-5 in FIG. 4, and as such, will be discussed with reference thereto.

The head 30 comprises a cap 38 and a filler 40.

The cap 38 of the head 30 is cylindrically shaped, hollow, has an open bottom 42 and a substantially closed top 44, and is for selective rotational resting in the recess 26 in the movable member 22.

The filler 40 of the head 30 is a ring 48, which by definition has a centrally and axially disposed through bore 50, and which fills the cap 38 of the head 30.

The ring 48 of the filler 40 of the head 30 is made from a hard metal to prevent crushing by a tool to gain a grip on the head 30.

### D. Specific Configuration of the Stem 32

The specific configuration of the stem 32 can best be seen in FIGS. 2, 3, 4, and 5, which are, respectively, an enlarged diagrammatic perspective view of the lock of an embodiment of the present invention identified by ARROW 2 in FIG. 1, a diagrammatic cross sectional view taken along LINE 3-3 in FIG. 2, a reduced exploded diagrammatic prospective view of the lock of an embodiment of the present invention shown in FIG. 2, and an enlarged diagrammatic cross sectional view taken along LINE 5-5 in FIG. 4, and as such, will be discussed with reference thereto.

The stem 32 comprises a lower portion 52, an upper portion 54, and a flange 56.

The lower portion 52 of the stem 32 is cylindrically shaped, and has a lower end 58 with threads 60 for selectively engaging in the threaded through bore 28 in the fixed member 24.

The upper portion 54 of the stem 32 is cylindrically shaped, extends coaxially from, and is wider than, the lower portion 52 of the stem 32, and is received in the centrally and axially disposed through bore 50 in the ring 48 of the filler 40 of the head 30.

The flange 56 of the stem 32 is disk-shaped, separates, is wider than, and extends coaxially with, the lower portion 52 of the stem 32 and the upper portion 54 of the stem 32, and is as wide as the head 30.

### E. Specific Configuration of the First Locking Apparatus 34

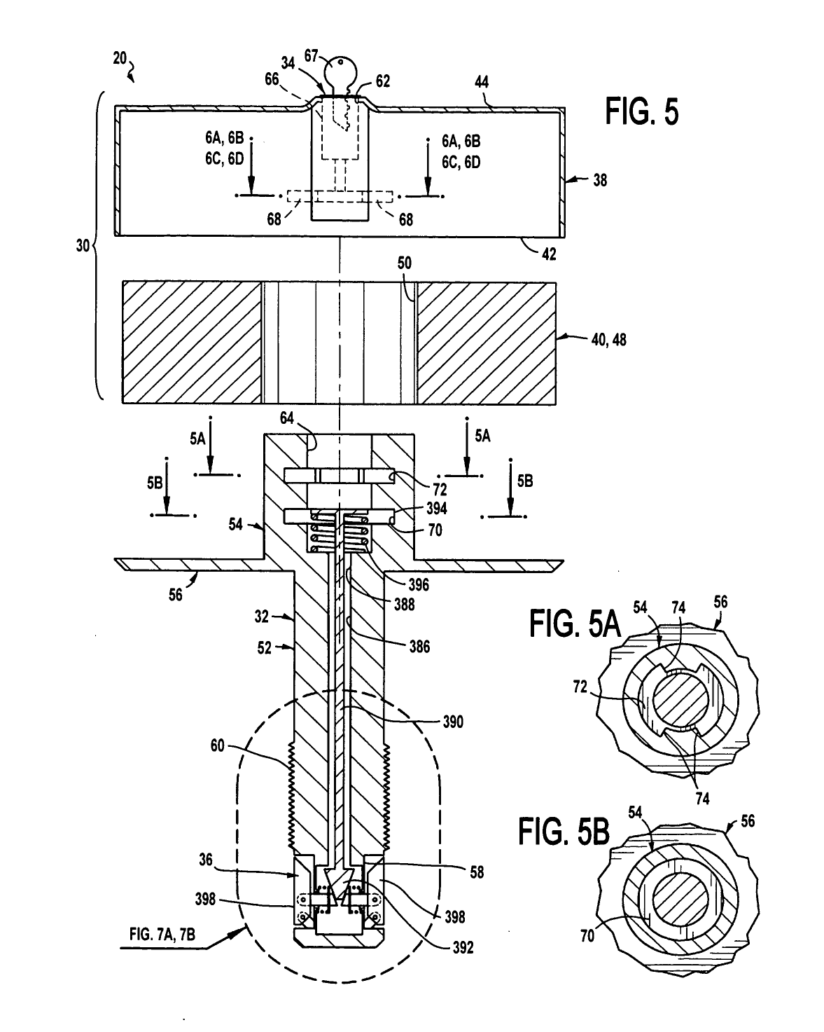

The specific configuration of the first locking apparatus 34 can best be seen in FIGS. 2, 3, 4, 5, 5A, and 5B, which are, respectively, an enlarged diagrammatic perspective view of the lock of an embodiment of the present invention identified by ARROW 2 in FIG. 1, a diagrammatic cross sectional view taken along LINE 3-3 in FIG. 2, a reduced exploded diagrammatic prospective view of the lock of an embodiment of the present invention shown in FIG. 2, an enlarged diagrammatic cross sectional view taken along LINE 5-5 in FIG. 4, a reduced diagrammatic cross sectional view taken along LINE 5A-5A in FIG. 5, and a reduced diagrammatic cross sectional view taken along LINE 5B-5B in FIG. 5, and as such, will be discussed with reference thereto.

The first locking apparatus 34 includes the substantially closed top 44 of the cap 38 of the head 30 having a centrally and axially disposed through bore 62.

The first locking apparatus 34 further includes the upper portion 54 of the stem 32 having a centrally and axially disposed through bore 64 that communicates with the centrally and axially disposed through bore 62 in the substantially closed top 44 of the cap 38 of the head 30.

The first locking apparatus 34 comprises a key lock cylinder 66.

The key lock cylinder 66 of the first locking apparatus 34 is operated by a key 67, depends fixedly in the centrally and axially disposed through bore 62 in the substantially closed top 44 of the cap 38 of the head 30 of the first locking apparatus 34 to rotate therewith, and depends rotatably in the centrally and axially disposed through bore 64 in the upper portion 54 of the stem 32 of the first locking apparatus 34.

The first locking apparatus 34 further comprises a pin arrangement 68.

The key lock cylinder 66 of the first locking apparatus 34 is operatively connected to the pin arrangement 68 of the first locking apparatus 34. The pin arrangement 68 of the first locking apparatus 34 extends from, and retracts into, the key lock cylinder 66 of the first locking apparatus 34 by rotation of the key 67 of the key lock cylinder 66 of the first locking apparatus 34.

The first locking apparatus 34 further includes the upper portion 54 of the stem 32 having a lower annular groove 70 and an upper annular groove 72.

The lower annular groove 70 of the upper portion 54 of the stem 32 of the first locking apparatus 34 is coaxial with, is wider than, and communicates with, the centrally and axially disposed through bore 64 in the upper portion 54 of the stem 32 of the first locking apparatus 34, and is disposed above the flange 56 of the stem 32.

The upper annular groove 72 of the upper portion 54 of the stem 32 of the first locking apparatus 34 is coaxial with, is wider than, and communicates with, the centrally and axially disposed through bore 64 in the upper portion 54 of the stem 32 of the first locking apparatus 34, and is disposed above, and is as wide as, the lower annular groove 70 of the upper portion 54 of the stem 32 of the first locking apparatus 34.

The pin arrangement 68 of the first locking apparatus 34 selectively engages in one of the lower annular groove 70 of the upper portion 54 of the stem 32 of the first locking apparatus 34 and the upper annular groove 72 of the upper portion 54 of the stem 32 of the first locking apparatus 34 at a time.

As shown in FIG. 5A, the upper annular groove 72 of the upper portion 54 of the stem 32 of the first locking apparatus 34 is not continuously open therearound by virtue of bosses 74 in the upper portion 54 of the stem 32 of the first locking apparatus 34 extending thereinto so as to prevent the pin arrangement 68 of the first locking apparatus 34 from rotating freely therearound, but rather allowing engagement with the bosses 74 in the upper portion 54 of the stem 32 of the first locking apparatus 34, and in so doing, allows engagement of the head 30 with the stem 32 to thereby allow rotation of the stem 32 when the head 30 is rotated thereby allowing unthreading of the stem 32 from the fixed member 24, and thereby unlocking the movable member 22 from the fixed member 24.

As shown in FIG. 5B, the lower annular groove 70 of the upper portion 54 of the stem 32 of the first locking apparatus 34 is continuously open therearound so as to allow the pin arrangement 68 of the first locking apparatus 34 to rotate freely therearound, and in so doing, prevents engagement of the head 30 with the stem 32 to thereby prevent rotation of the stem 32 when the head 30 is rotated thereby preventing unthreading of the stem 32 from the fixed member 24, and thereby locking the movable member 22 to the fixed member 24.

### F. Specific Configuration of an Embodiment of the Pin Arrangement 168 of the First Locking Apparatus 134

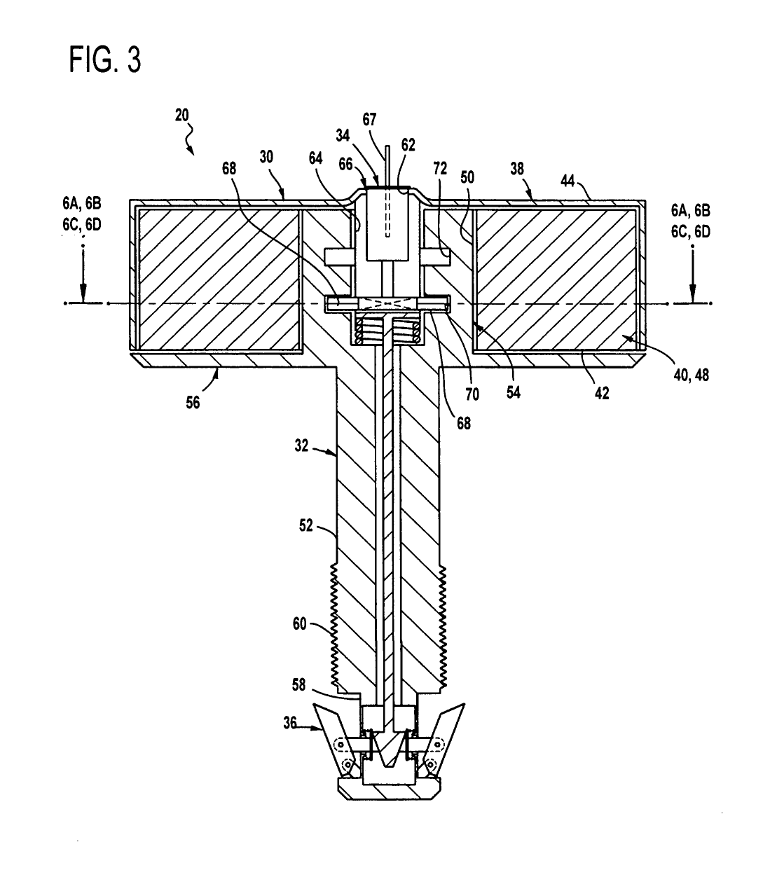

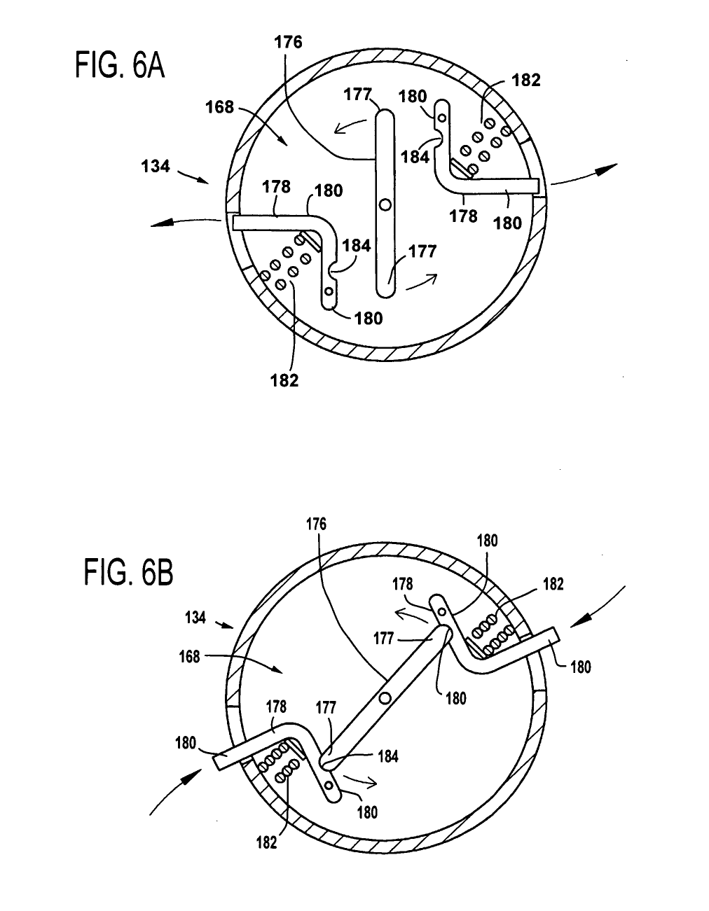

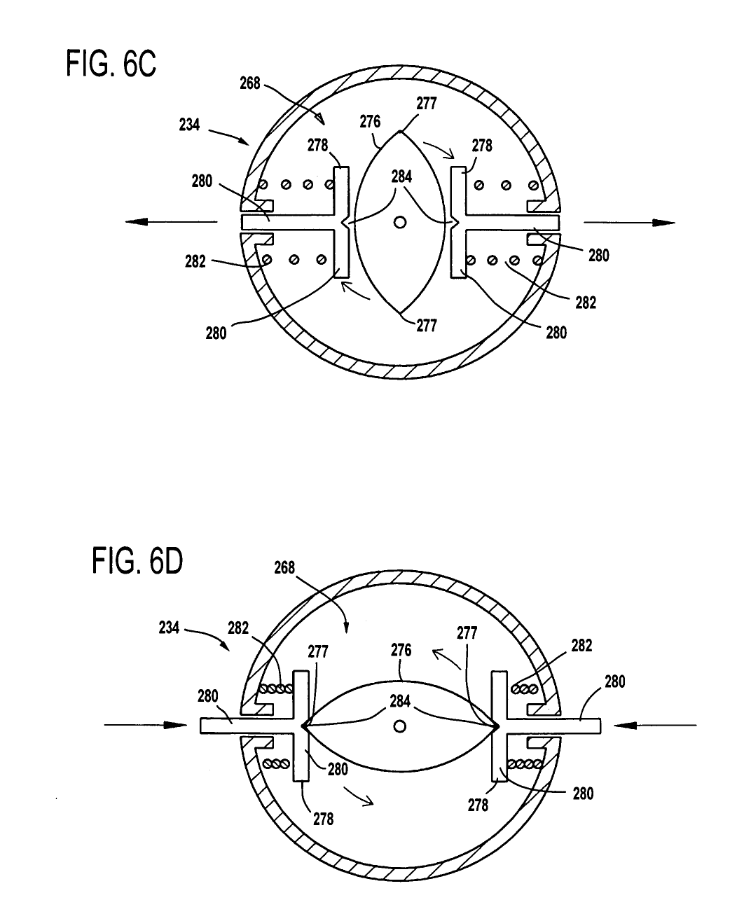

The specific configuration of an embodiment of the pin arrangement 168 of the first locking apparatus 134 can best be seen in FIGS. 6A and 6B, which are, respectively, an enlarged diagrammatic cross sectional view taken along LINE 6A-6A in FIGS. 3, 4, and 5 of an embodiment of the pin arrangement of the first locking apparatus in the retracted position, and an enlarged diagrammatic cross sectional view taken along LINE 6B-6B in FIGS. 3, 4, and 5 of an embodiment of the pin arrangement of the first locking apparatus in the extended position, and as such, will be discussed with reference thereto.

The pin arrangement 168 of the first locking apparatus 134 comprises a centrally disposed actuator rod 176. The centrally disposed actuator rod 176 of the pin arrangement 168 of the first locking apparatus 134 has a pair of ends 177, and depends laterally from, and is operatively connected to, the key lock cylinder 66 of the first locking apparatus 134 so as to rotate with the key 67 of the key lock cylinder 66 of the first locking apparatus 134.

The pin arrangement 168 of the first locking apparatus 134 further comprises a pair of diametrically opposed and L-shaped pins 178.

Each diametrically opposed and L-shaped pin 178 of the pin arrangement 168 of the first locking apparatus 134 has, by definition, a pair of legs 180.

One leg 180 of each diametrically opposed and L-shaped pin 178 of the pin arrangement 168 of the first locking apparatus 134 is pivotally mounted so as to allow the other leg 180 of each diametrically opposed and L-shaped pin 178 of the pin arrangement 168 of the first locking apparatus 134 to extend from, and retract into, each of the lower annular groove 70 of the upper portion 54 of the stem 32 of the first locking apparatus 34 and the upper annular groove 72 of the upper portion 54 of the stem 32 of the first locking apparatus 34.

The pin arrangement 168 of the first locking apparatus 134 further comprises a pair of springs 182. As shown in FIG. 6A, the pair of springs 182 of the pin arrangement 168 of the first locking apparatus 134 bias the other leg 180 of each diametrically opposed and L-shaped pin 178 of the pin arrangement 168 of the first locking apparatus 134, respectively, into a normally retracted position.

The one leg 180 of each diametrically opposed and L-shaped pin 178 of the pin arrangement 168 of the first locking apparatus 134 has a notch 184.

The notch 184 in the one leg 180 of each diametrically opposed and L-shaped pin 178 of the pin arrangement 168 of the first locking apparatus 134 selectively receive the pair of ends 177 of the centrally disposed actuator rod 176 of the pin arrangement 168 of the first locking apparatus 134, and as shown in FIG. 6B, when the notch 184 in the one leg 180 of each diametrically opposed and L-shaped pin 178 of the pin arrangement 168 of the first locking apparatus 134 receive the pair of ends 177 of the centrally disposed actuator rod 176 of the pin arrangement 168 of the first locking apparatus 134 and the key 67 of the key lock cylinder 66 of the first locking apparatus 134 is rotated, the other leg 180 of each diametrically opposed and L-shaped pin 178 of the pin arrangement 168 of the first locking apparatus 134 assume the extended position.

### G. Specific Configuration of Another Embodiment of the Pin Arrangement 268 of the First Locking Apparatus 234

The specific configuration of another embodiment of the pin arrangement 268 of the first locking apparatus 234 can best be seen in FIGS. 6C and 6D, which are, respectively, an enlarged diagrammatic cross sectional view taken along LINE 6C-6C in FIGS. 3, 4, and 5 of another embodiment of the pin arrangement of the first locking apparatus in the retracted position, and an enlarged diagrammatic cross sectional view taken along LINE 6D-6D in FIGS. 3, 4, and 5 of another embodiment of the pin arrangement of the first locking apparatus in the extended position, and as such, will be discussed with reference thereto.

The pin arrangement 268 of the first locking apparatus 234 comprises a centrally disposed and oval-shaped actuator rod 276. The centrally disposed and oval-shaped actuator rod 276 of the pin arrangement 268 of the first locking apparatus 234 has a pair of ends 277, and depends laterally from, and is operatively connected to, the key lock cylinder 66 of the first locking apparatus 234 so as to rotate with the key 67 of the key lock cylinder 66 of the first locking apparatus 234.

The pin arrangement 268 of the first locking apparatus 234 further comprises a pair of diametrically opposed and T-shaped pins 278.

Each diametrically opposed and T-shaped pin 278 of the pin arrangement 268 of the first locking apparatus 234 has, by definition, a pair of legs 280.

One leg 280 of each diametrically opposed and T-shaped pin 278 of the pin arrangement 268 of the first locking apparatus 234 is slidably mounted so as to allow the other leg 280 of each diametrically opposed and T-shaped pin 278 of the pin arrangement 268 of the first locking apparatus 234 to extend from, and retract into, each of the lower annular groove 70 of the upper portion 54 of the stem 32 of the first locking apparatus 34 and the upper annular groove 72 of the upper portion 54 of the stem 32 of the first locking apparatus 34.

The pin arrangement 268 of the first locking apparatus 234 further comprises a pair of springs 282. As shown in FIG. 6C, the pair of springs 282 of the pin arrangement 268 of the first locking apparatus 234 bias the other leg 280 of each diametrically opposed and T-shaped pin 278 of the pin arrangement 268 of the first locking apparatus 234, respectively, into a normally retracted position.

The one leg 280 of each diametrically opposed and T-shaped pin 278 of the pin arrangement 268 of the first locking apparatus 234 has a notch 284.

The notch 284 in the one leg 280 of each diametrically opposed and T-shaped pin 278 of the pin arrangement 268 of the first locking apparatus 234 selectively receive the pair of ends 277 of the centrally disposed and oval-shaped actuator rod 276 of the pin arrangement 268 of the first locking apparatus 234, and as shown in FIG. 6D, when the notch 284 in the one leg 280 of each diametrically opposed and T-shaped pin 278 of the pin arrangement 268 of the first locking apparatus 234 receive the pair of ends 277 of the centrally disposed and oval-shaped actuator rod 276 of the pin arrangement 268 of the first locking apparatus 234 and the key 67 of the key lock cylinder 66 of the first locking apparatus 234 is rotated, the other leg 280 of each diametrically opposed and T-shaped pin 278 of the pin arrangement 268 of the first locking apparatus 234 assume the extended position.

### H. Specific Configuration of the Second Locking Apparatus 36

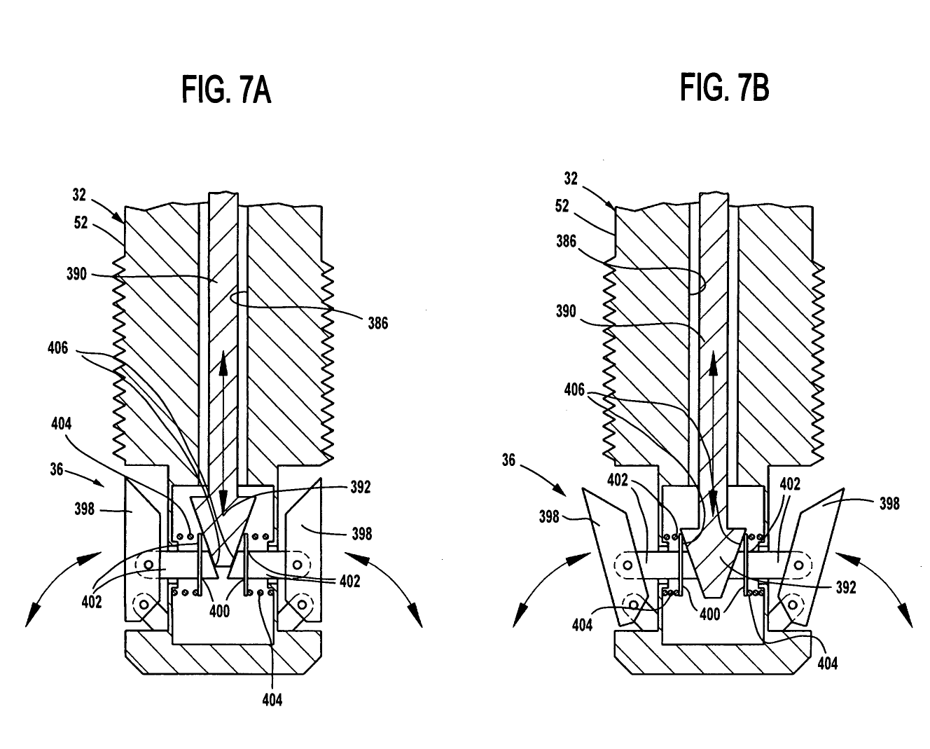

The specific configuration of the second locking apparatus 36 can best be seen in FIGS. 5, 7A, and 7B, which are, respectively, an enlarged diagrammatic cross sectional view taken along LINE 5-5 in FIG. 4, an enlarged diagrammatic cross sectional view of the area generally enclosed by the dotted curve identified by ARROW 7A in FIG. 5 of the second locking apparatus in the retracted-unlocked position, and an enlarged diagrammatic cross sectional view of the area generally enclosed by the dotted curve identified by ARROW 7B in FIG. 5 of the second locking apparatus in the extended-locked position, and as such, will be discussed with reference thereto.

The second locking apparatus 36 includes the lower portion 52 of the stem 32 having a centrally and axially disposed through bore 386.

The second locking apparatus 36 further includes the flange 56 of the stem 32 having a centrally and axially disposed through bore 388.

The centrally and axially disposed through bore 386 in the lower portion 52 of the stem 32 of the second locking apparatus 36, the centrally and axially disposed through bore 64 in the upper portion 54 of the stem 32, and the centrally and axially disposed through bore 388 in the flange 56 of the stem 32 of the second locking apparatus 36 are coaxial.

The second locking apparatus 36 comprises a rod 390.

The rod 390 of the second locking apparatus 36 has a pointed lower end 392 and a flanged upper end 394, and is axially movably mounted in a lower portion of the centrally and axially disposed through bore 64 in the upper portion 54 of the stem 32, the centrally and axially disposed through bore 388 in the flange 56 of the stem 32 of the second locking apparatus 36, and the centrally and axially disposed through bore 386 in the lower portion 52 of the stem 32 of the second locking apparatus 36.

The second locking apparatus 36 further comprises a spring 396.

The spring 396 of the second locking apparatus 36 sits in the lower portion of the centrally and axially disposed through bore 64 in the upper portion 54 of the stem 32, against the flanged upper end 394 of the rod 390 of the second locking apparatus 36, and biases the rod 390 of the second locking apparatus 36 inward.

The second locking apparatus 36 further comprises a pair of levers 398. The pair of levers 389 of the second locking apparatus 36 are pivotally mounted to the lower end 58 of the lower portion 52 of the stem 32.

The second locking apparatus 36 further comprises a pair of diametrically opposed and T-shaped pins 400.

Each diametrically opposed and T-shaped pin 400 of the second locking apparatus 36 has, by definition, a pair of legs 402.

One leg 402 of each diametrically opposed and T-shaped pin 400 of the second locking apparatus 36 is laterally slidably mounted so as to allow the other leg 402 of each diametrically opposed and T-shaped pin 400 of the second locking apparatus 36 to extend from, and retract into, the lower end 58 of the lower portion 52 of the stem 32.

The second locking apparatus 36 further comprises a pair of springs 404. As shown in FIG. 7A, the pair of springs 404 of the second locking apparatus 36 bias the other leg 402 of each diametrically opposed and T-shaped pin 400 of the second locking apparatus 36, respectively, into a normally retracted-unlocked position.

The one leg 402 of each diametrically opposed and T-shaped pin 400 of the second locking apparatus 36 has a ramped surface 406.

The ramped surface 406 of the one leg 402 of each diametrically opposed and T-shaped pin 400 of the second locking apparatus 36 are selectively engaged by the pointed lower end 392 of the rod 390 of the second locking apparatus 36.

As shown in FIG. 7B, when the pointed lower end 392 of the rod 390 of the second locking apparatus 36 is pushed downwardly by the pin arrangement 68 of the first locking apparatus 34 engaging in the lower annular groove 70 in the upper portion 54 of the stem 32 of the first locking apparatus 34 to thereby push downwardly on the flanged upper end 394 of the rod 390 of the second locking apparatus 36 against biasing of the spring 396 of the second locking apparatus 36, the pointed lower end 392 of the rod 390 of the second locking apparatus 36 pushes outwardly the ramped surface 406 of the one leg 402 of each diametrically opposed and T-shaped pin 400 of the second locking apparatus 36 causing the pair of levers 389 of the second locking apparatus 36 to extend to the locked position.

### I. The Configuration of Another Embodiment of the Lock 520

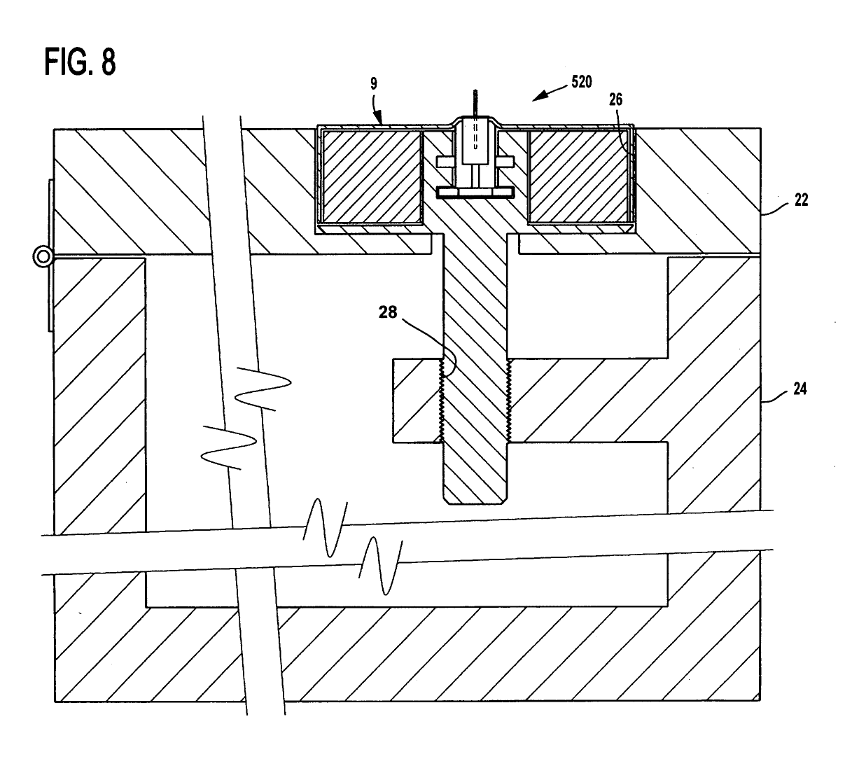

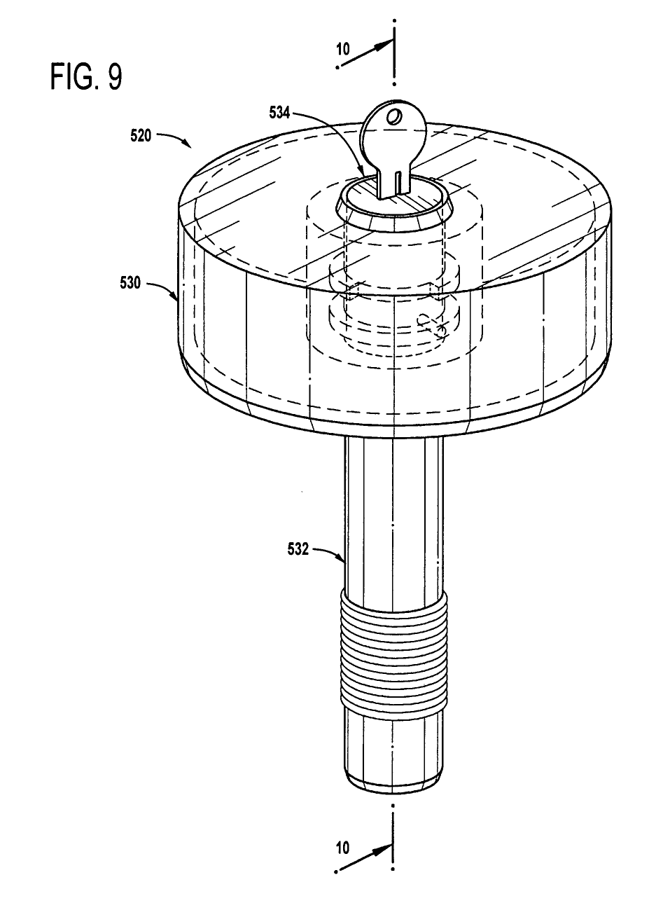

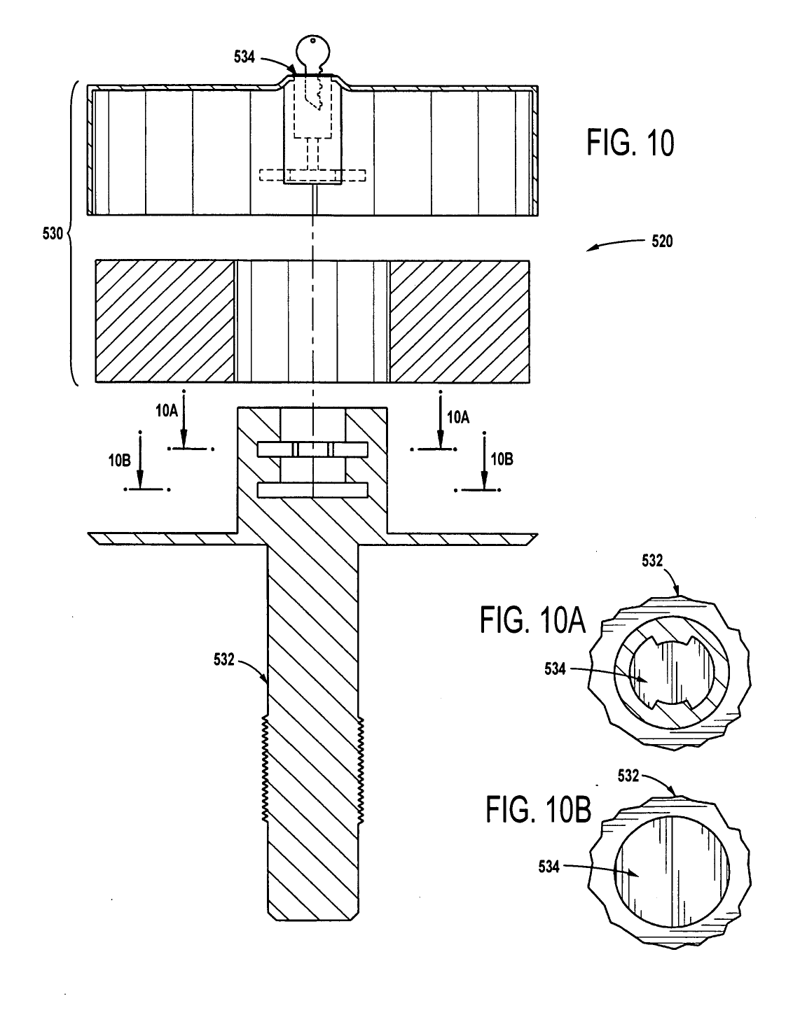

The configuration of another embodiment of the lock 520 can best be seen in FIGS. 8, 9, 10, 10A, and 10B, which are, respectively, a diagrammatic cross sectional view of the lock of another embodiment of the present invention locking a movable member to a fixed member, an enlarged diagrammatic perspective view of the lock of another embodiment of the present invention identified by ARROW 9 in FIG. 8, a diagrammatic cross sectional view taken along LINE 10-10 in FIG. 9, a reduced diagrammatic cross sectional view taken along LINE 10A-10A in FIG. 10, and a reduced diagrammatic cross sectional view taken along LINE 10B-10B in FIG. 10, and as such, will be discussed with reference thereto.

The lock 520 is similar to the lock 20, but without the second locking apparatus 36.

As shown in FIG. 8, the lock 520 is for locking the movable member 22 to the fixed member 24, wherein the movable member 22 has the recess 26 and the fixed member 24 has the threaded through bore 28.

As shown in FIGS. 9, 10, 10A, and 10B, the lock 520 comprises the head 530, the stem 532, and the first locking apparatus 534.

### J. Impression

It will be understood that each of the elements described above or two or more together may also find a useful application in other types of constructions differing from the types described above.

While an embodiment of the present invention has been illustrated and described as embodied in a lock for locking a movable member to a fixed member, however, it is not limited to the details shown, since it will be understood that various omissions, modifications, substitutions, and changes in the forms and details of an embodiment of the present invention illustrated and its operation can be made by those skilled in the art without departing in any way from the spirit of an embodiment of the present invention.

Without further analysis the foregoing will so fully reveal the gist of an embodiment of the present invention that others can by applying current knowledge readily adapt it for various applications without omitting features that from the standpoint of prior art fairly constitute characteristics of the generic or specific aspects of an embodiment of the present invention.

The invention claimed is:

1. A lock for locking a movable member to a fixed member, wherein the movable member has a recess, and wherein the fixed member has a threaded through bore, said lock comprising:
a) a head;
b) a stem; and
c) first means;
wherein said head is for selective rotational resting in the recess in the movable member;
wherein said stem selectively movably depends from said head;
wherein said stem is for selectively engaging in the threaded through bore in the fixed member; and
wherein said first means is for selectively preventing rotation of said head relative to said stem to thereby prevent rotation of said stem and withdrawal thereof from the threaded through bore in the fixed member.

2. The lock of claim 1, wherein said head comprises:
a) a cap; and
b) a filler.

3. The lock of claim 2, wherein said cap of said head is cylindrically shaped;
wherein said cap of said head is hollow;
wherein said cap of said head has an open bottom;
wherein said cap of said head has a substantially closed top; and
wherein said cap of said head is for selective rotational resting in the recess in the movable member.

4. The lock of claim 2, wherein said filler of said head is a ring;
wherein said ring of said filler of said head has a centrally and axially disposed through bore; and
wherein said filler of said head fills said cap of said head.

5. The lock of claim 4, wherein said ring of said filler of said head is made from a hard metal to prevent crushing by a tool to gain a grip on said head.

6. The lock of claim 3, wherein said stem comprises:
a) a lower portion;
b) an upper portion; and
c) a flange.

7. The lock of claim 6, wherein said lower portion of said stem is cylindrically shaped;
wherein said lower portion of said stem has a lower end;
wherein said lower end of said lower portion of said stem has threads; and
wherein said threads on said lower end of said lower portion of said stem are for selectively engaging in the threaded through bore in the fixed member.

8. The lock of claim 6, wherein said upper portion of said stem is cylindrically shaped;
wherein said upper portion of said stem extends coaxially from said lower portion of said stem;
wherein said upper portion of said stem is wider than said lower portion of said stem; and
wherein said upper portion of said stem is received in said centrally and axially disposed through bore in said ring of said filler of said head.

9. The lock of claim 6, wherein said flange of said stem is disk-shaped;
wherein said flange of said stem separates said lower portion of said stem and said upper portion of said stem;
wherein said flange of said stem is wider than said lower portion of said stem and said upper portion of said stem;
wherein said flange of said stem extends coaxially with said lower portion of said stem and said upper portion of said stem; and
wherein said flange of said stem is as wide as said head.

10. The lock of claim 6, wherein said first means includes said substantially closed top of said cap of said head having a centrally and axially disposed through bore.

11. The lock of claim 10, wherein said first means includes said upper portion of said stem having a centrally and axially disposed through bore; and
wherein said centrally and axially disposed through bore in said upper portion of said stem communicates with said centrally and axially disposed through bore in said substantially closed top of said cap of said head.

12. The lock of claim 11, wherein said first means includes a key lock cylinder.

13. The lock of claim 12, wherein said key lock cylinder of said first means is operated by a key;
wherein said key lock cylinder of said first means depends fixedly in said centrally and axially disposed through bore in said substantially closed top of said cap of said head of said first means to rotate therewith; and
wherein said key lock cylinder of said first means depends rotatably in said centrally and axially disposed through bore in said upper portion of said stem of said first means.

14. The lock of claim 13, wherein said key lock cylinder of said first means is operatively connected to a pin arrangement.

15. The lock of claim 14, wherein said pin arrangement of said first means extends from, and retracts into, said key lock cylinder of said first means by rotation of said key of said key lock cylinder of said first means.

16. The lock of claim 14, wherein said first means includes said upper portion of said stem having:
a) a lower annular groove; and
b) an upper annular groove.

17. The lock of claim 16, wherein said lower annular groove in said upper portion of said stem of said first means is coaxial with said centrally and axially disposed through bore in said upper portion of said stem of said first means;
wherein said lower annular groove in said upper portion of said stem of said first means is wider than said centrally and axially disposed through bore in said upper portion of said stem of said first means;
wherein said lower annular groove in said upper portion of said stem of said first means communicates with said centrally and axially disposed through bore in said upper portion of said stem of said first means; and
wherein said lower annular groove in said upper portion of said stem of said first means is disposed above said flange of said stem.

18. The lock of claim 16, wherein said upper annular groove in said upper portion of said stem of said first means is coaxial with said centrally and axially disposed through bore in said upper portion of said stem of said first means;
wherein said upper annular groove in said upper portion of said stem of said first means is wider than said centrally and axially disposed through bore in said upper portion of said stem of said first means;
wherein said upper annular groove in said upper portion of said stem of said first means communicates with said centrally and axially disposed through bore in said upper portion of said stem of said first means;
wherein said upper annular groove in said upper portion of said stem of said first means is disposed above said lower annular groove in said upper portion of said stem of said first means; and
wherein said upper annular groove in said upper portion of said stem of said first means is as wide as said lower annular groove of said upper portion of said stem of said first means.

19. The lock of claim 16, wherein said pin arrangement of said first means selectively engages in one of said lower annular groove in said upper portion of said stem of said first means and said upper annular groove in said upper portion of said stem of said first means at a time.

20. The lock of claim 16, wherein said upper annular groove in said upper portion of said stem of said first means is not continuously open therearound by virtue of bosses in said upper portion of said stem of said first means extending thereinto so as to prevent said pin arrangement of said first means from rotating freely therearound, but rather allowing engagement with said bosses in said upper portion of said stem of said first means, and in so doing, allows engagement of said head with said stem to thereby allow rotation of said stem when said head is rotated thereby allowing unthreading of said stem from the fixed member, and thereby unlocking the movable member from the fixed member.

21. The lock of claim 16, wherein said lower annular groove in said upper portion of said stem of said first means is continuously open therearound so as to allow said pin arrangement of said first means to rotate freely therearound, and in so doing, prevents engagement of said head with said stem to thereby prevent rotation of said stem when said head is rotated thereby preventing unthreading of said stem from the fixed member, and thereby locking the movable member to the fixed member.

22. The lock of claim 16, wherein said pin arrangement of said first means includes a centrally disposed actuator rod.

23. The lock of claim 22, wherein said centrally disposed actuator rod of said pin arrangement of said first means has a pair of ends;
wherein said centrally disposed actuator rod of said pin arrangement of said first means depends laterally from said key lock cylinder of said first means; and
wherein said centrally disposed actuator rod of said pin arrangement of said first means is operatively connected to said key lock cylinder of said first means so as to rotate with said key of said key lock cylinder of said first means.

24. The lock of claim 23, wherein said pin arrangement of said first means includes a pair of diametrically opposed and L-shaped pins.

25. The lock of claim 24, wherein each diametrically opposed and L-shaped pin of said pin arrangement of said first means has a pair of legs; and
wherein one leg of each diametrically opposed and L-shaped pin of said pin arrangement of said first means is pivotally mounted so as to allow the other leg of each diametrically opposed and L-shaped pin of said pin arrangement of said first means to extend from, and retract into, each of said lower annular groove in said upper portion of said stem of said first means and said upper annular groove in said upper portion of said stem of said first means.

26. The lock of claim 25, wherein said pin arrangement of said first means includes a pair of springs.

27. The lock of claim 26, wherein said pair of springs of said pin arrangement of said first means bias said other leg of each diametrically opposed and L-shaped pin of said pin arrangement of said first means, respectively, into a normally retracted position.

28. The lock of claim 25, wherein said one leg of each diametrically opposed and L-shaped pin of said pin arrangement of said first means has a notch.

29. The lock of claim 28, wherein said notch in said one leg of each diametrically opposed and L-shaped pin of said pin arrangement of said first means selectively receive said pair of ends of said centrally disposed actuator rod of said pin arrangement of said first means, and when said notch of said one leg of each diametrically opposed and L-shaped pin of said pin arrangement of said first means receive said pair of ends of said centrally disposed actuator rod of said pin arrangement of said first means and said key of said key lock cylinder of said first means is rotated, said other leg of each diametrically opposed and L-shaped pin of said pin arrangement of said first means assume an extended position.

30. The lock of claim 14, wherein said pin arrangement of said first means includes a centrally disposed and oval-shaped actuator rod.

31. The lock of claim 16, wherein said centrally disposed and oval-shaped actuator rod of said pin arrangement of said first means has a pair of ends;
wherein said centrally disposed and oval-shaped actuator rod of said pin arrangement of said first means depends laterally from said key lock cylinder of said first means; and
wherein said centrally disposed and oval-shaped actuator rod of said pin arrangement of said first means is operatively connected to said key lock cylinder of said first means so as to rotate with said key of said key lock cylinder of said first means.

32. The lock of claim 31, wherein said pin arrangement of said first means includes a pair of diametrically opposed and T-shaped pins.

33. The lock of claim 32, wherein each diametrically opposed and T-shaped pin of said pin arrangement of said first means has a pair of legs; and
wherein one leg of each diametrically opposed and T-shaped pin of said pin arrangement of said first means is slidably mounted so as to allow the other leg of each diametrically opposed and T-shaped pin of said pin arrangement of said first means to extend from, and retract into, each of said lower annular groove in said upper portion of said stem of said first means and said upper annular groove in said upper portion of said stem of said first means.

34. The lock of claim 33, wherein said pin arrangement of said first means includes a pair of springs.

35. The lock of claim 34, wherein said pair of springs of said pin arrangement of said first means bias said other leg of each diametrically opposed and T-shaped pin of said pin arrangement of said first means, respectively, into a normally retracted position.

36. The lock of claim 33, wherein said one leg of each diametrically opposed and T-shaped pin of said pin arrangement of said first means has a notch.

37. The lock of claim 36, wherein said notch in said one leg of each diametrically opposed and T-shaped pin of said pin arrangement of said first means selectively receive said pair of ends of said centrally disposed and oval-shaped actuator rod of said pin arrangement of said first means, and when said notch in said one leg of each diametrically opposed and T-shaped pin of said pin arrangement of said first means receive said pair of ends of said centrally disposed and oval-shaped actuator rod of said pin arrangement of said first means and said key of said key lock cylinder of said first means is rotated, said other leg of each diametrically opposed and T-shaped pin of said pin arrangement of said first means assume an extended position.

38. The lock of claim 29 or 37, further comprising second means; and
wherein said second means is for selectively preventing retraction of said stem from the threaded through bore in the fixed member to thereby further selectively prevent removal of said lock from the fixed member.

39. The lock of claim 38, wherein said second means depends operatively from said stem; and
wherein said second means is operatively connected to said first means.

40. The lock of claim 38, wherein said second means includes said lower portion of said stem having a centrally and axially disposed through bore.

41. The lock of claim 40, wherein said second means includes said flange of said stem having a centrally and axially disposed through bore.

42. The lock of claim 41, wherein said centrally and axially disposed through bore in said lower portion of said stem of said second means, said centrally and axially disposed through bore in said upper portion of said stem, and said centrally and axially disposed through bore in said flange of said stem of said second means are coaxial.

43. The lock of claim 41, wherein said second means includes a rod.

44. The lock of claim 43, wherein said rod of said second means has:
a) a pointed lower end; and
b) a flanged upper end.

45. The lock of claim 44, wherein said rod of said second means is axially movably mounted in a lower portion of said centrally and axially disposed through bore in said upper portion of said stem, said centrally and axially disposed through bore in said flange of said stem of said second mean, and said centrally and axially disposed through bore in said lower portion of said stem of said second means.

46. The lock of claim 45, wherein said second means includes a spring.

47. The lock of claim 46, wherein said spring of said second means sits in said lower portion of said centrally and axially disposed through bore in said upper portion of said stem, against said flanged upper end of said rod of said second means; and
wherein said spring of said second means biases said rod of said second means inward.

48. The lock of claim 45, wherein said second means includes a pair of levers.

49. The lock of claim 48, wherein said pair of levers of said second means are pivotally mounted to said lower end of said lower portion of said stem.

50. The lock of claim 48, wherein said second means includes a pair of diametrically opposed and T-shaped pins.

51. The lock of claim 50, wherein each diametrically opposed and T-shaped pin of said second means has a pair of legs; and
wherein one leg of each diametrically opposed and T-shaped pin of said second means is laterally slidably mounted so as to allow the other leg of each diametrically opposed and T-shaped pin of said second means to extend from, and retract into, said lower end of said lower portion of said stem.

52. The lock of claim 51, wherein said second means includes a pair of springs.

53. The lock of claim 52, wherein said pair of springs of said second means bias said other leg of each diametrically opposed and T-shaped pin of said second means, respectively, into a normally retracted-unlocked position.

54. The lock of claim 52, wherein said one leg of each diametrically opposed and T-shaped pin of said second means has a ramped surface.

55. The lock of claim 54, wherein said ramped surface of said one leg of each diametrically opposed and T-shaped pin of said second means are selectively engaged by said pointed lower end of said rod of said second means.

56. The lock of claim 54, wherein when said pointed lower end of said rod of said second means is pushed downwardly by said pin arrangement of said first means engaging in said lower annular groove of said upper portion of said stem of said first means to thereby push downwardly on said flanged upper end of said rod of said second means against biasing of said spring of said second means, said pointed lower end of said rod of said second means pushes outwardly said ramped surface of said one leg of each diametrically opposed and T-shaped pin of said second means causing said pair of levers of said second means to extend to a locked position.
